(19) United States
(12) Patent Application Publication
(10) Pub. No.: US 2006/0049201 A1
(43) Pub. Date: Mar. 9, 2006

(54) Dispensers particularly but not exclusively for cigarette packets

(76) Inventor: Klaus Heinrich Lanz, Montague Gardens (ZA)

Correspondence Address: STITES & HARBISON PLLC, 1199 NORTH FAIRFAX STREET, SUITE 900, ALEXANDRIA, VA, 22314, US

(21) Appl. No.: 10/510,631

(22) PCT Filed: Apr. 9, 2003
(86) PCT No.: PCT/ZA03/00047

§ 371 Date: Oct. 8, 2004

(30) Foreign Application Priority Data
Apr. 10, 2002 (ZA) 02/2792
Aug. 16, 2002 (ZA) 02/6565

(51) Int. Cl. G07F 11/16

(52) U.S. Cl. 221/226

(57) ABSTRACT

A dispenser (10) for dispensing packets particularly, but not exclusively cigarette packets, is disclosed. The dispenser (10) comprises a magazine (14) for holding a plurality of packets (P1, P2, P3, P4) standing in an upright position and a column (12) for dispensing the packets. A pressure plate (52) is provided for pushing the plurality of packets towards a dispensing end of the magazine (14). The dispenser (10) also comprises a dispensing mechanism (76) for driving a coil spring (126) which pushes the first packet (P1) of the plurality of packets in the magazine (14) upwardly into the column (12) and causes the uppermost packet (P6) within the column (12) to be dispensed.

### FIELD OF THE INVENTION

This invention relates dispensers particularly, but not exclusively, for cigarette packets.

### BACKGROUND TO THE INVENTION

Various factors, such as restrictive legislation and the need to make the best possible use of space in retail outlets, has given rise to a need for a dispenser which can not only store a number of packets but can also display the front face of at least one packet and dispense packets one at a time to customers.

The present invention seeks to provide such a dispenser which will store packets and dispense them one at a time. It also seeks to provide, as a subsidiary feature, a dispenser in which at least one packet's front face is displayed for advertising purposes.

The present invention further seeks to provide means for producing data relating to the dispensing of cigarette packets as well as means to prevent tampering and/or theft.

### BRIEF DESCRIPTION OF THE INVENTION

According to one aspect of the present invention there is provided a dispenser for dispensing packets particularly, but not exclusively cigarette packets, said dispenser comprising a magazine for holding a plurality of packets standing in an upright position, means for pushing the plurality of packets towards a dispensing end of the magazine, means for defining a column at said dispensing end of the magazine, means for lifting the leading packet of the plurality upwards out of the magazine and into said column to prevent the packet from dropping back down said column.

The column can have a displaceable closure element located at the upper end thereof, a packet at the upper end of the column, when being lifted in the column, engaging and displacing the closure element to permit that packet to emerge from the upper end of the column.

Said closure element can be in the form of a hinged lid, a packet at the upper end of the column, when being lifted in the column, pressing on the lid to lift it and, permitting that packet to emerge from the upper end of the column.

Said closure element can be in the form of an elongate comb with flexible bristles, a packet at the upper end of the column, when being lifted in the column, displacing the flexible bristles and protruding therethrough.

Said means for pushing the packets towards the dispensing end of the magazine can comprise a pressure plate and a spring. The spring is preferably an elongate leaf spring which is wound to coil form, the inner end of the wound coil being fixed and the outer end of the coil being attached to the pressure plate.

Said lifting means can comprise a lever structure which is pivotally mounted at one end and which has a platform at the other end, there being means for swinging said lever structure in an upward arc so that said platform bears on the underside of a packet to be lifted.

Said lever structure can be in the form of a parallelogram linkage so that said platform moves vertically.

The means for swinging the lever structure in an upward arc can comprise a rotatable cam with lobes one of which, each time the cam rotates, bears on the underside of said lever structure to lift said structure.

Said dispenser can include sensor means located at the upper end of said column and said sensor means being activated by a packet being dispensed.

Said lifting means can comprise an elongate resiliently flexible element, there being means for reciprocating said element so that one end of the element bears on the underside of a packet to be lifted.

Said dispensing means can comprise a first spool, an electric motor for driving said first spool, a second spool, an endless belt entrained around said spools, and a linkage connected to said belt for reciprocal movement as the belt moves, said linkage being connected to said lifting means for reciprocating said lifting means.

Said aligning means can be in the form of a plurality of spools, said resiliently flexible element passing between said spools and being aligned with the column by the spools.

According to a further aspect of the present invention there is provided a dispensing apparatus comprising a first compartment having a top surface on which a cash register can stand, a second compartment which is vertically elongate, one end of the first compartment communicating with the lower end of the second compartment, a plurality of dispensers as defined above in said compartments, said magazines being side-by-side in the first compartment and said columns being side-by-side in the second compartment.

The second compartment, on the side thereof remote from the first compartment, can have a transparent window so that packets in the columns in the second compartment are visible from outside the dispensing apparatus.

### BRIEF DESCRIPTION OF THE DRAWINGS

For a better understanding of the present invention, and to show how the same may be carried into effect, reference will now be made, by way of example, to the accompanying drawings in which:

FIGS. 1 to 6 are side elevations of a dispenser in accordance with the present invention in different operative conditions;

FIG. 7 is a pictorial view of the dispenser;

FIG. 8 is a side elevation of a dispensing mechanism;

FIG. 9 is a top plan view of the dispensing mechanism of FIG. 8;

FIG. 10 is a side elevation of a pressure plate to an enlarged scale;

FIGS. 11 to 16 are side elevations of a further form of dispenser in different operative conditions;

FIG. 17 is a pictorial view of the dispenser of FIGS. 11 to 16;

FIG. 18 is a pictorial view of a lockable container.

### DETAILED DESCRIPTION OF THE DRAWINGS

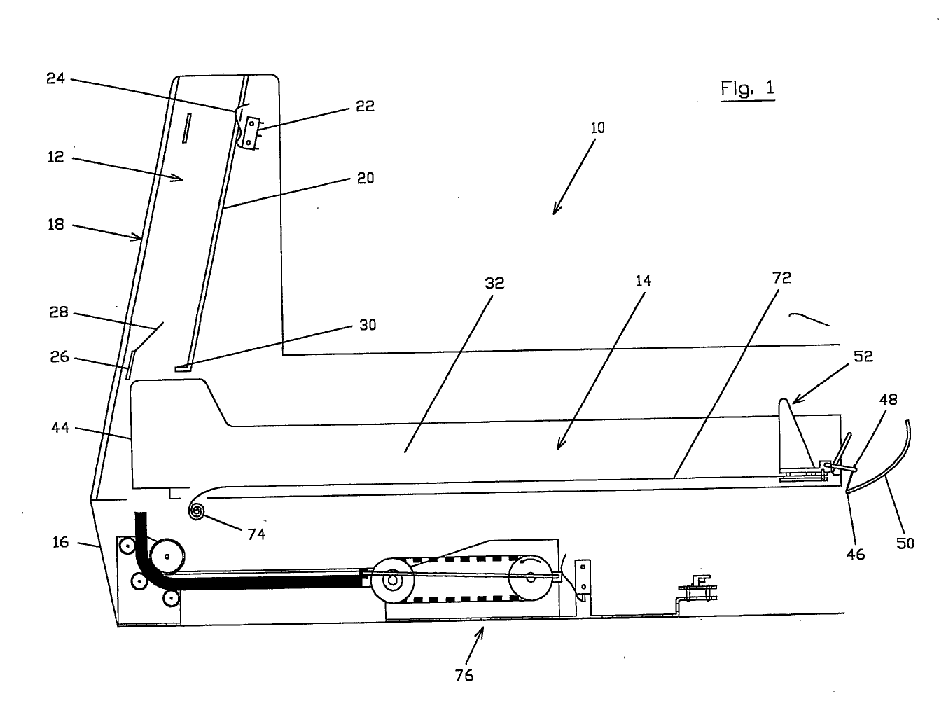

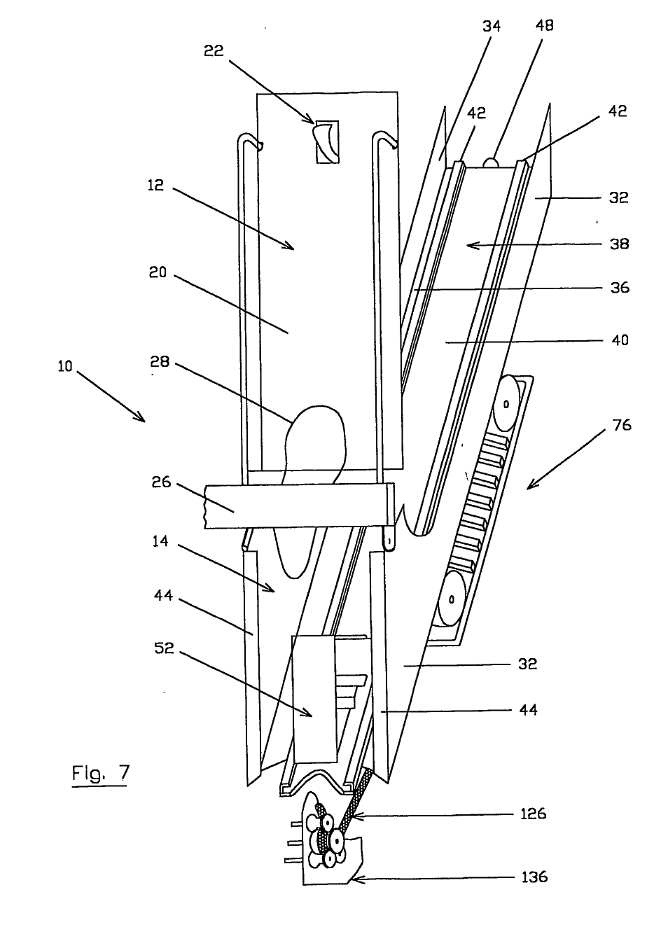

Referring firstly to FIGS. 1 and 7, the dispenser 10 illustrated comprises an upstanding column 12 and a horizontal magazine 14.

The lower end of the column 12 is bounded by a front wall 16 and is open at the back. A window 18 is provided in the front wall 16. The upper portion of the column 12 is bounded by the window 18 at the front and at the rear by a wall 20. The column 12 has no lid and is therefore open at the top. A switch 22 is mounted in the rear wall 20 at the upper end of the column 12. The operating arm of the switch 22 is designated 24.

A member 26 extends across the window 18 and has a wire spring 28 mounted thereon. The wire spring 28 is of inverted U-shape and leans inwardly away from the front wall 16 and towards the back wall 20 as can best be seen in FIG. 7.

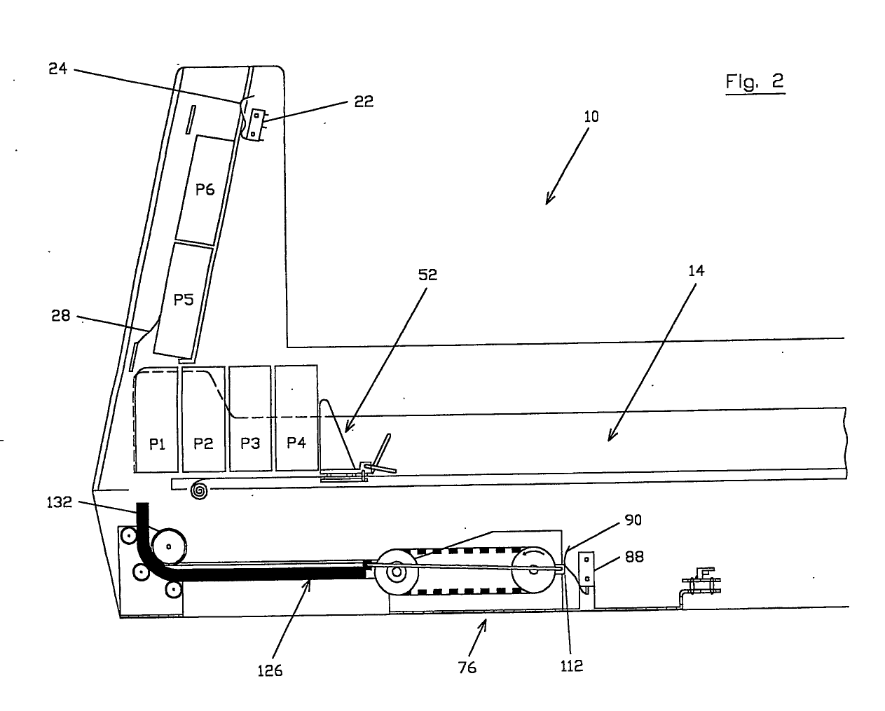

A stop 30, which can be in the form of an L-shaped bracket, is attached to the lower end of the rear wall 20 of the column 12. The stop 30 lies beneath the lower edge of a packet located in the column 12 and prevents the packet from dropping down. This situation can best be seen in FIG. 2 where two packets P5 and P6 are shown in the column 12.

A closure element (not shown) can be provided at the upper end of the column 12. The closure element can be in the form of a hinged lid that is forced open by the upward motion of a packet being dispensed.

Alternatively, the closure element can be in the form of an elongate comb with flexible bristles (not shown). In this form the bristles can be secured at one end along the upper rear edge of the column 12 with the bristles extending across the width of the column 12 such that the free ends of the bristles rest on the upper front edge of the column 12. The upward motion of the packet being dispensed causes the packet to protrude through the bristles so that it becomes available for removal from the dispenser 10.

Referring specifically to FIG. 7, the magazine 14 comprises elongate side walls 32 and 34 and is open at its front end and rear ends. The side walls 32, 34 are bent inwardly along their lower edges to define a two part base wall 36 with a slot 38 along the centre thereof. An elongate channel 40 is provided in the slot 38. The upper edges of the flanges of the channel 40 are each bent twice through 90° to provide two horizontally extending grooves 42.

The front ends of the side walls 32, 34 are bent through 90° to form two vertical stops 44. The stops 44 abut a cigarette packet during operation of the dispenser 10 and serve to maintain a plurality of packets in the magazine 14.

A transverse release bar 46 (FIG. 1) is mounted at the rear end of the magazine 14 and comprises a centrally located release element 48 and two cams 50. The element 48 is of inverted U-shape. The cams 50 are located at either end of the release bar 46 and extend rearwardly and upwardly in a direction away from the magazine 14.

The release bar 46 is tensioned by means of a spring (not shown) attached at one end to the bar 46 and at its other end to the underside of the magazine 14, such that the U-shaped element 48 extends upwardly at an angle away from the magazine 14.

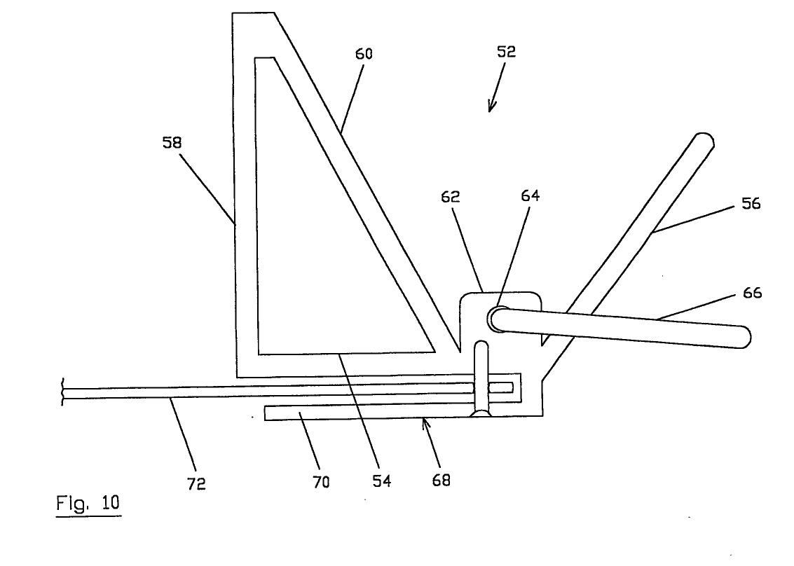

Referring specifically to FIG. 10, a pressure plate 52 fits between the side walls 32 and 34. The pressure plate 52 is preferably manufactured from a single sheet of material using a laser cutter and is bent to form a horizontal section 54, a rearwardly angled finger plate 56, a vertical front wall 58 and a rearwardly sloping face 60.

The rearwardly facing surface of the face 60 can have a picture or image (not shown) attached thereto, the picture depicting the type of cigarette packet to be loaded into the magazine 14. This picture is only be visible during loading of the magazine 14.

The finger plate 56 is used to pull the pressure plate 52 back (to the right in the drawings) during loading of the magazine 14.

A rectangular housing 62 is mounted on the horizontal section 54 of the pressure plate 52 between the rearwardly sloping face 60 and the finger plate 56. The housing 62 includes a bore 64 for receiving a latch 66. The latch 66 is rectangular in configuration. The finger plate 56 protrudes through the space bounded by the latch 66.

A plate 68 is secured to the underside of the horizontal section 54. The plate 68 is shaped to provide two outwardly directed horizontally extending edges 70. The edges 70 are in the grooves 42 provided in the elongate channel 40 thereby to locate the pressure plate 52 whilst permitting it to move along the magazine 14.

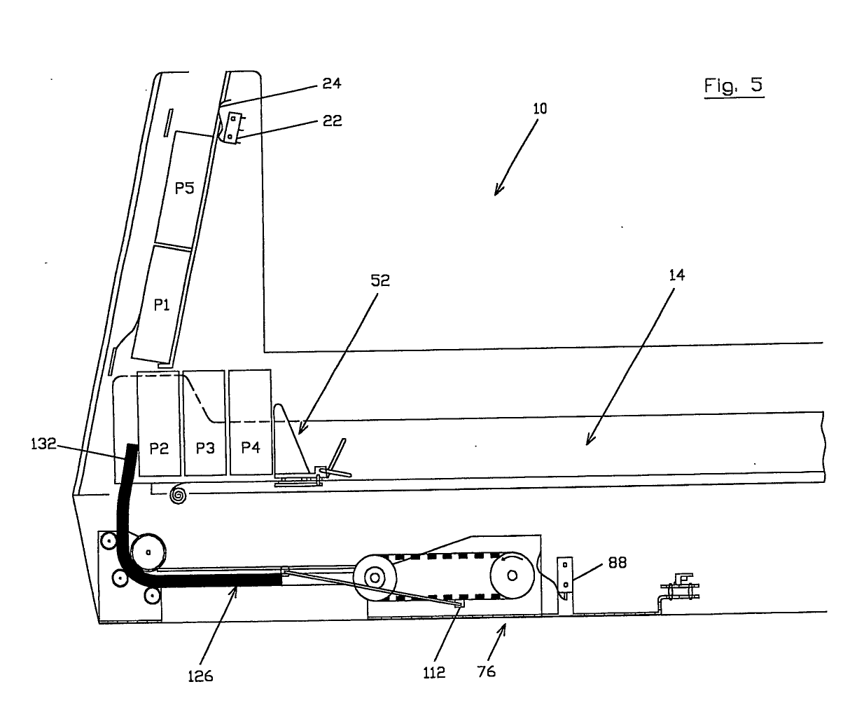

An elongate spring strip 72 (see FIG. 1) has one end fastened between the underneath of the horizontal section 54 and the upper surface of the plate 68. The other end of the strip 72 is attached to a roller 74 which turns on a fixed spindle (not shown) and the strip 72 is wound around the roller 74 when the pressure plate 52 is in the forward position shown, for example, in FIG. 5.

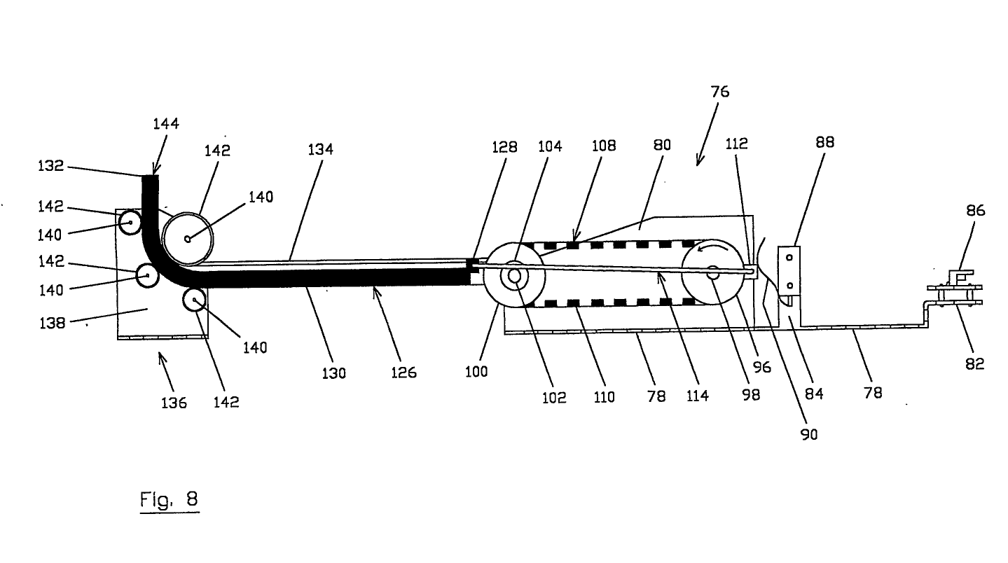

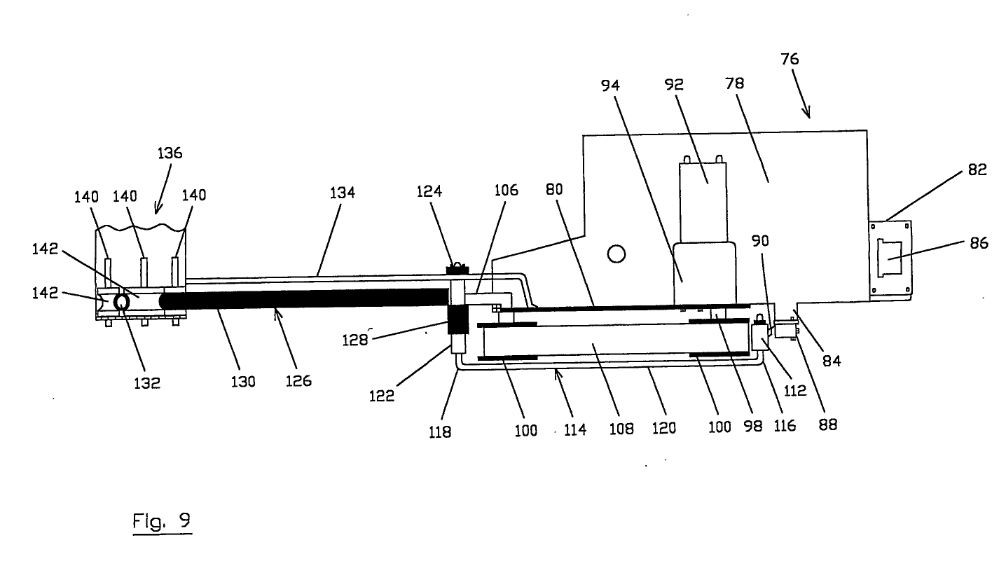

Below and to one side of the magazine 14 there is a support structure 76 (FIGS. 8 and 9). The support structure 76 is preferably manufactured from a single sheet of material using a laser cutter and is bent to form a horizontal section 78, a vertical side wall 80, a raised rear plate 82 and a strut 84.

A circuit board 86 is mounted on the raised rear plate 82 and a switch 88 is mounted on the strut 84. The operating arm of the switch 88. is designated 90.

An electric motor 92 (FIG. 9) is mounted on the horizontal section 78 of the structure 76. The motor 92, via a gearbox 94, drives a spool 96 which is fixed on the motor's drive-shaft 98. The drive-shaft 98 extends through a hole (not shown) in the side wall 80 such that the spool 96 and the motor 92 are located on opposite sides of the wall 80.

The electric motor 92 is wired through the switch 88 and through a manually operable switch (not shown) in parallel with the switch 88.

A further spool 100 is provided adjacent the front edge of the side wall 80. The spool 100 is mounted on a shaft spindle 102 and is held on the shaft spindle 102 by an end-cap 104. The spool 100 is free to rotate about the shaft spindle 102.

A drive rod 106 is welded, or attached by suitable attachment means, to the side wall 80 such that the rod 106 and the spool 100 are on opposite sides of the side wall 80. The rod 106 extends towards the front wall 16 of the dispenser 10 so that it is substantially parallel to the side wall 80.

A toothed belt 108 is entrained around the spools 96 and 100. The belt 108 includes teeth 110 located on the inwardly facing surface thereof. The teeth 110 cooperate with similarly shaped recesses (not shown) provided in the outer surface of the spool 96. The teeth 110 and recesses cooperate to locate the belt 108 on the spool and assist in preventing slippage.

Rotation of the spool 96 about the drive-shaft 98 in the direction of the arrows (see FIGS. 2 to 6) results in simultaneous rotation of the spool 100 about the shaft spindle 102.

A housing 112 is secured to the outer surface of the belt 108. The housing 112 has a bore (not shown) therein for receiving a U-shaped member 114. The configuration of the U-shaped member 114 can best be seen in FIG. 9 and consists of a rod bent twice through 90° to form two parallel arms 116 and 118 and an elongate cross-bar 120. The arm 116 is secured within the housing 112 such that the elongate cross-bar 120 extends substantially parallel to the belt 108.

In the dispenser's inoperative or rest condition, the housing 112 is positioned such that it is in contact with the free end of the operating arm 90 of the switch 88. The switch 88 is a normally closed switch and thus, in this position with the arm 90 engaged, the circuit into which the switch 88 is connected is open and no power flows therethrough.

A cylindrical sleeve 122 is located around the arm 118 and is held in position by an end-cap 124 attached to the free end of the arm 118. The underside of the sleeve 122 rests on the rod 106. The sleeve 122 is free to rotate on the arm 118.

Referring specifically to FIG. 8, a coil spring 126 is provided which comprises a short portion 128 and an elongate portion 130 which are integral with one another. The portion 128 is co-axial with the sleeve 122 and the elongate portion 130 is connected to the rod 106.

An L-shaped guide rod 134 is welded, or secured by other attachment means, to one side of the wall 80. The rod 134 extends perpendicular to the wall 80 and is then bent through 90° so that its major portion is substantially parallel to the rod 106. The lower surface of the guide rod 134 rests on the upper surface of the sleeve 122 adjacent the end-cap 124. The guide rod 134 assists in guiding the U-shaped member 114 on its forward and return strokes during operation of the dispenser 10.

An L-shaped bracket 136 is mounted adjacent the front wall 16 of the dispenser 10 such that its vertical flange 138 is perpendicular to the dispenser's front wall 16. The bracket 136 has four pins 140 protruding from the flange 138. The pins 140 are substantially parallel to the front wall 16. Four spools 142 are located on the pins 140, each spool 142 having a centrally located circumferential groove (not shown) therein.

On assembly of the dispenser 10, the elongate portion 130 of the coil spring 126 is positioned between the spools 142 so that the free end of the elongate portion 130 protrudes upwardly into the column 12. This portion of the spring 126 within the column 12 is designated 132.

An end-cap 144 is inserted into the free end of the portion 132. The end-cap 144 serves to provide a flat contact surface which engages with the underside of a packet during operation of the dispenser 10.

In use of the dispenser 10 the pressure plate 52 is pulled to the rear of the magazine 14 (the right hand end in FIGS. 1 to 7). The latch 66 comes into contact with the angled release element 48 and slides upwardly until it hooks over the element 48. This prevents the pressure plate 52 from sliding along the magazine 14 towards the front wall 16 of the dispenser 10 under the action of the spring strip 72.

Cigarette packets P1, P2, P3, P4 (FIGS. 2 to 6) are then loaded into the magazine 14. Each packet stands upright with its major faces vertical. The bottom face of each of the packets rest on the bottom wall of the magazine 14.

When the release bar 46 is rotated by pushing on the cams 50, the latch 66 disengages from the element 48 and the pressure plate 52 is released. The strip 72 coils onto the roller 74 thereby displacing the plate 52 and pushing all the packets forward along the magazine 14. The front packet P1 abuts the stops 44 and is visible in the window 18 from the front of the dispenser 10. In this position, the upper surface of the end cap 144 of the coil spring 126 is in contact with the lower surface of the packet P1.

In the illustrated form, the column 12 is tall enough to hold two packets stacked on each other. These two packets, designated P5 and P6, and the packet P1 in the window 18, are all visible from outside the dispenser 10.

When the motor 92 is activated, using the manually operable switch (not shown), the drive-shaft 98 rotates the spool 96 and thus the upper run of the belt 108 moves to the left (as viewed in the drawings). Movement of the belt 108 causes the housing 112 to move upwardly and away from the operating arm 90 of the switch 88. The arm 90 moves into its normally closed position and subsequent opening of the manually operable switch does not result in the motor 92 stopping as power to the motor 92 is now supplied through the switch 88.

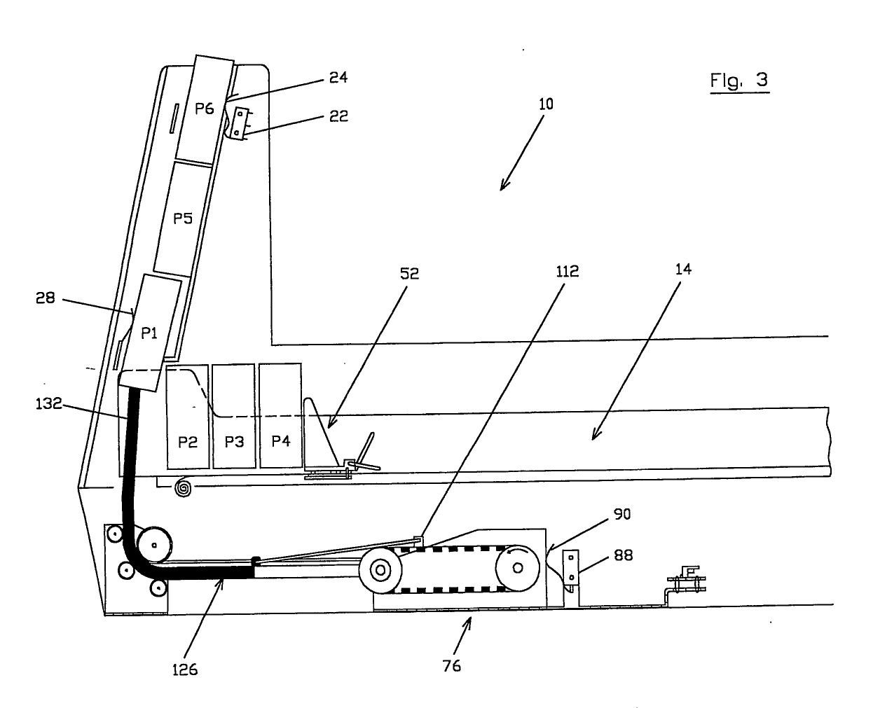

Continued movement of the belt 108 causes the housing 112 to move to the left and thus the coil spring 126 carried by the rod 106 is also pushed to the left. The portion 132 of the coil spring 126 is pushed upwardly into the column 12, carrying the packet P1 upwardly with it (see FIG. 3).

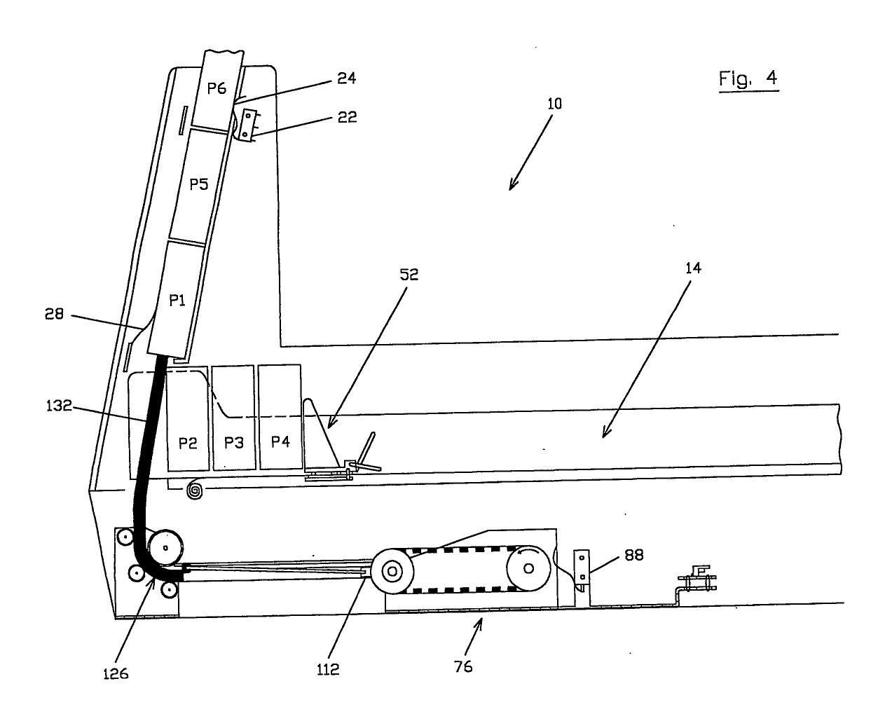

Once the packet P1 has been lifted sufficiently into the column 12 such that it is no longer in contact with packet P2, the pressure plate 52, under the action of the spring strip 72, pushes the packet P2 forward so that it abuts the spring 126 (see FIG. 4). However, the spring 126 is sufficiently stiff to prevent the packet P2 from being pushed any further forward by the pressure plate 52.

As the packet P1 is pushed up into the column 12, the upper surface of the packet P1 bears on the underneath of the packet P5, pushing both packets P5 and P6 upwardly. This causes the packet P6 to protrude from the column 12 and it then becomes available for removal from the dispenser 10.

As the packet P1 is pushed further upwards, the upper surface thereof comes into contact with the spring 28 as illustrated in FIG. 3. Continued upward movement of the packet P1 into the column 12 causes the packet P1 to tilt rearwardly, under the action of the spring 28, so that the packet P1 is pressed against the rear wall 20. The lower edge of the packet P1 comes into contact with the stop 30 and thus the packet P1 is prevented from dropping down out of the column 12.

The switch 22 is operated by the packet (P6 as illustrated) engaging the operating arm 24 as it emerges from the column 12. The switch 22 is connected to a circuit (not shown) and can be used to provide dispensing statistics, as well as to prevent tampering.

During normal operation, the switch 88 provides an electrical signal prior to such a signal being provided by the switch 22. However, if the switch 22 were to produce such a signal prior to a signal being received by the switch 88, as would be consistent with someone attempting to remove a packet manually from the column 12, then the circuit is designed to temporarily remove power from the dispenser 10 until the dispenser 10 is reset. The shutting down of the dispenser 10 could be coupled to an audible and/or visible alarm (not shown), as well as requiring the insertion of an overriding key by a supervisor.

Once the housing 112 has reached the extreme left position as shown in FIG. 4, the forward stroke of the dispenser 10 is complete and the portion 132 of the coil spring 126 is in its uppermost position within the column 12. Further motion (see FIG. 5) of the belt 108 results in the housing 112 moving to the right thereby causing the rod 106 to retract. This in turn causes the portion 132 of the coil spring 126 in the column 12 to descend. The packet P1 is held in the column 12 by the stop 30.

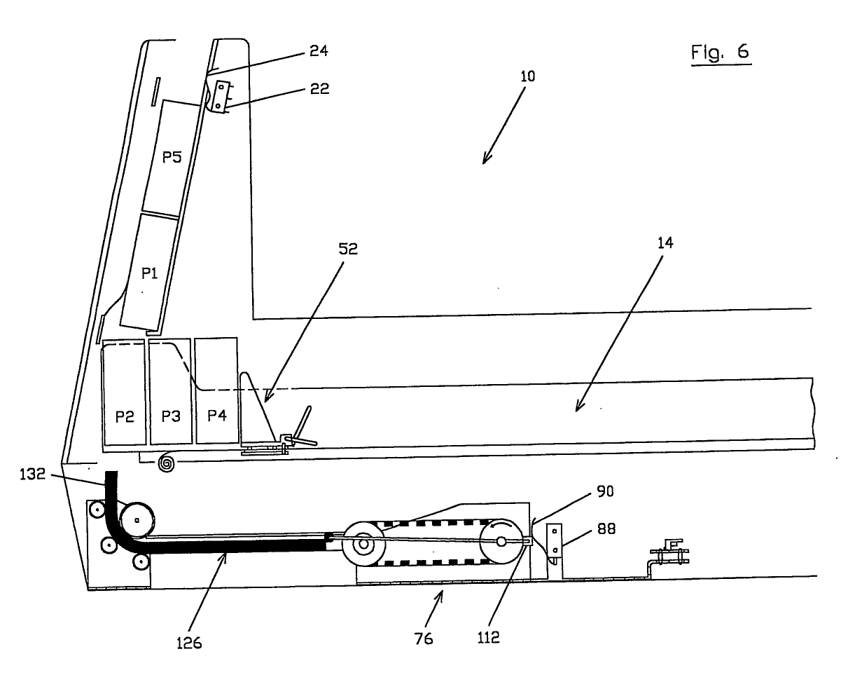

Referring now to FIG. 6, the housing 112 engages the operating arm 90 of the switch 88 and opens the circuit thereby removing power from the motor 92. Once the housing 112 has reached the position as shown in FIG. 6, the return stroke of the dispenser 10 is complete.

Furthermore, the portion 132 of the spring 126 has retracted sufficiently within the column 12 to allow the pressure plate 52 to push the packet P2 forwards so that it abuts the stops 44. The packet P2 in FIG. 6 is therefore in the same position as the packet P1 in FIG. 2.

In the preferred form, the manual operating switch is eliminated and the switch 88 is wired by means of a circuit (not shown) directly to a cash register (not shown). A signal received from the cash register that a packet of cigarettes is required, is transmitted via the circuit to the motor 92. The motor 92 is thus energized and the dispenser 10 operates in the manner described hereinbefore in order to dispense a packet of cigarettes.

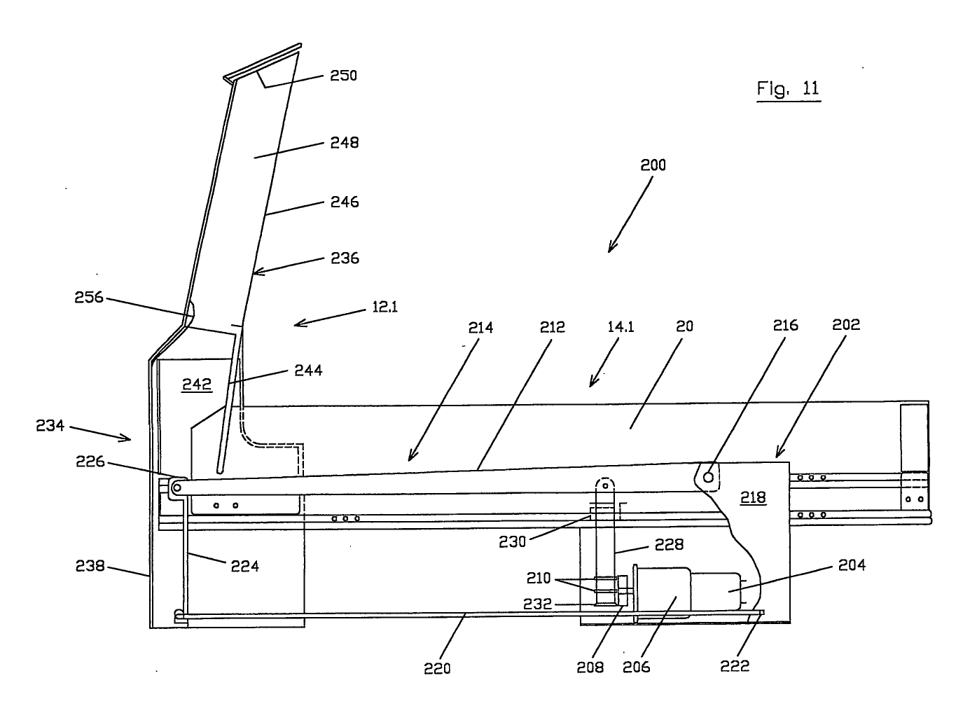

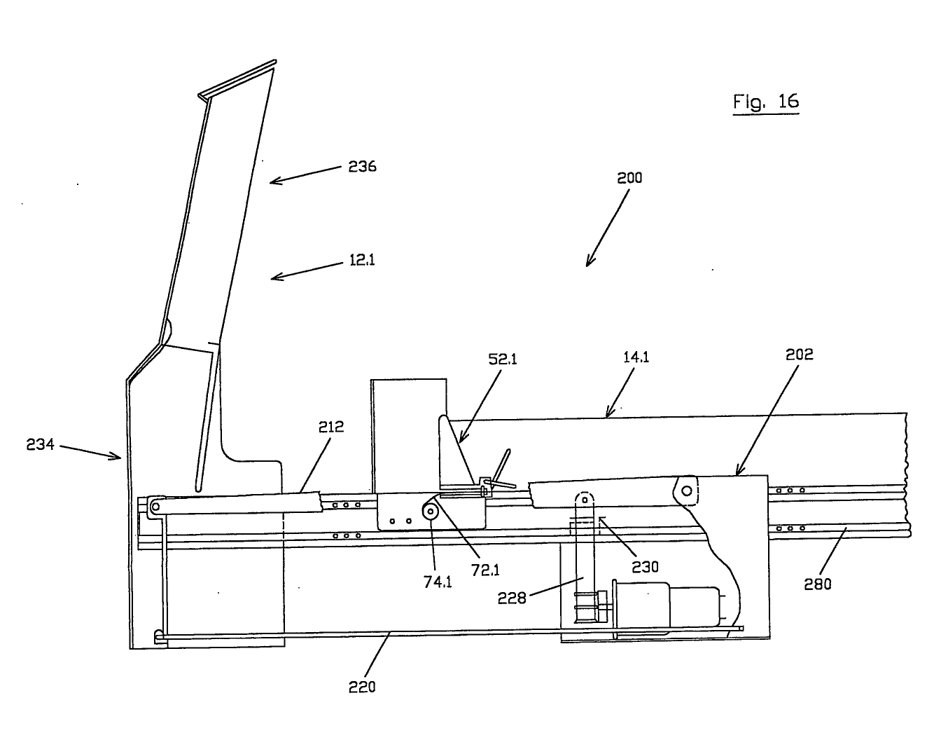

Referring now to FIGS. 11 to 17 a further form of dispenser is illustrated and is generally designated 200. Where applicable, the same reference numerals as used in FIGS. 1 to 10 have been used with the addition of the suffix .1.

Below and to one side of the magazine 14.1 there is a support structure 202. The structure 202 carries an electric motor 204 which, via a gearbox 206, drives a cam 208 of triangular shape. Pins 210 protrude from the cam 208, there being a pin 210 at each apex of the cam 208.

A lever 212 forming part of a lever structure 214 is pivotally mounted at 216 on a vertical plate 218 forming part of the support structure 202.

A tie rod 220 is pivotally mounted at 222 on the plate 218, and a rectangular, vertically positioned linking plate 224 joins the lever 212 and the rod 220 at the ends thereof remote from their pivotal mountings. The plate 224 is pivotally connected to both the tie rod 220 and the lever 212.

The upper edge of the plate 224 forms a platform 226 which extends across the magazine 14.1 at the forward end thereof.

The lever 212, rod 220, plate 218 and plate 224 form a parallelogram linkage which ensures that the platform 226 moves vertically.

An operating element 228 extends downwardly from the lever 212 and is pivotally mounted thereon. Guides 230 on the plate 218 ensure that the element 228 remains vertical at all times. At the lower end of the element 228 there is a follower 232 which co-operates with the pins 210.

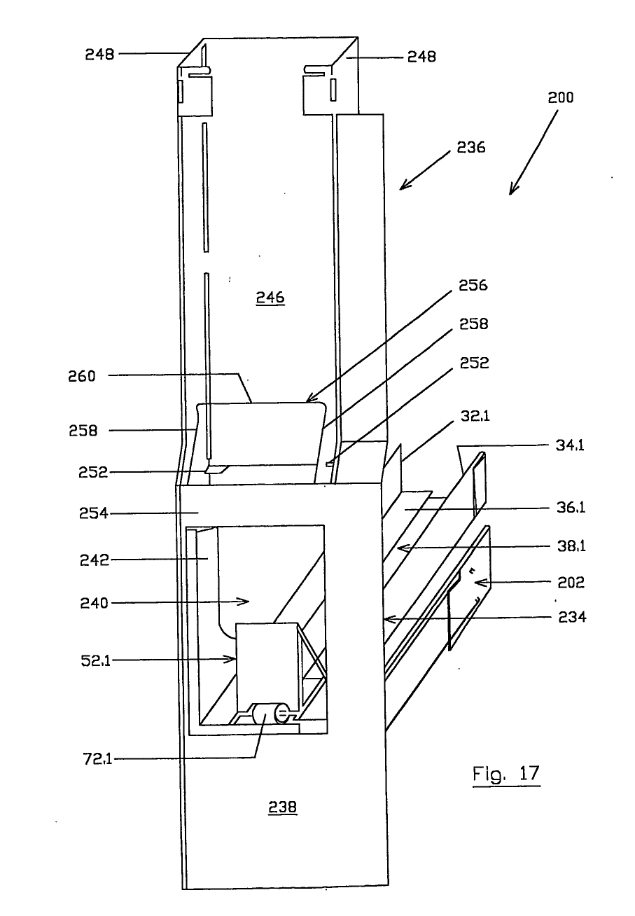

The column 12.1 comprises a lower section 234 and an upper section 236. The lower section 234 is bounded at the front by a wall 238 with a window 240 (FIG. 17) therein. The section 234 is open at the back and closed on one side by a side wall 242. At the other side the lower section 234 is open apart from a strut 244 which extends downwardly from the section 236. The lower end of the strut 244 is not fixed and the upper end of the strut 244 is integral with one of the walls 248.

The section 236 comprises a rear wall 246 and side walls 248. The section 236 slopes rearwardly and is closed at the top by a spring loaded lid 250 (not shown in FIG. 17). The column part 236 is open at the front. Packet supports 252 (FIG. 17) protrude forwardly from the rear wall 246.

Referring specifically to FIG. 17, a cross member 254 forms the lintel of the window 240 and has a wire spring 256 mounted on it. The wire spring 256 is of inverted channel shape and has legs 258 joined at their upper ends by a cross member 260. The spring 254 leans inwardly as best seen in FIG. 17.

A micro switch (not shown) is provided adjacent the pins 210. The motor 204 is wired through the micro switch and through a manually operable switch (not shown) in parallel with the micro switch.

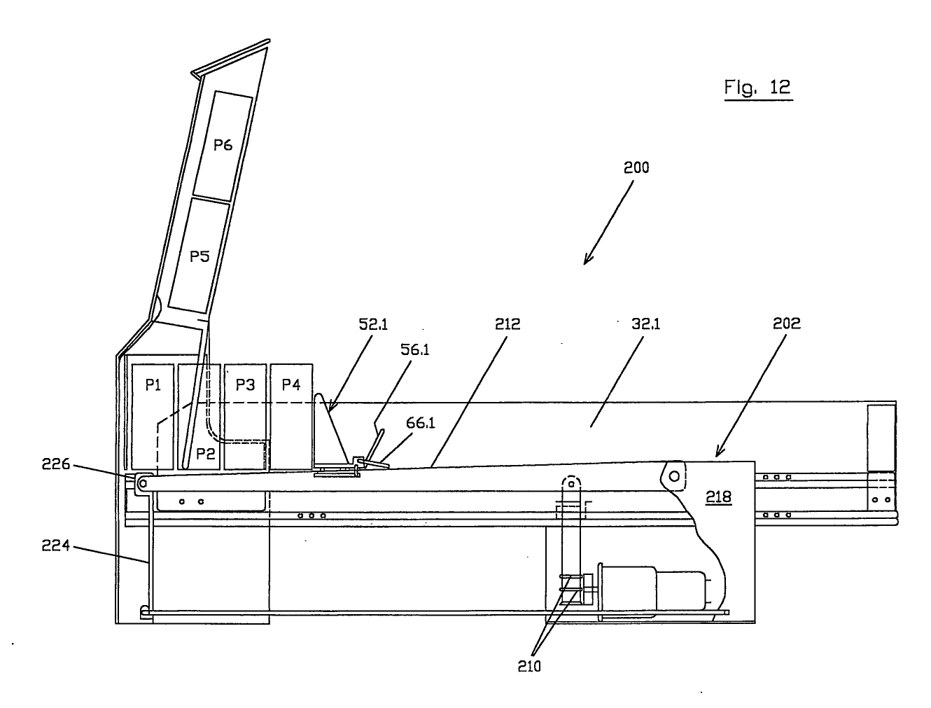

In use of the dispenser 200, the pressure plate 52.1 (not shown in FIG. 11) is pulled to the rear of the magazine 14.1 (the right hand end of FIGS. 11 to 16) and cigarette packets P1, P2, P3, P4 (FIGS. 12 to 15) are loaded into the magazine 14.1. Each packet stands upright with its major faces vertical. The bottom faces of the packets rest on the bottom wall of the magazine 14.1.

When the pressure plate 52.1 is released, the packets are all pushed forward along the magazine 14.1. The front packet P1 is in the window 240 with vertical edge zones of its front face pressed against the parts of the front wall 238 which bound the window 240. The leading packet P1 is, when the pressure plate 52.1 is released and moves forward, slid off the bottom wall of the magazine 14.1 and onto the platform 226. In the illustrated form, the upper section 236 is tall enough to hold two packets stacked one on another. These two packets, designated P5 and P6, and the packet designated P1 in the window 240, are visible from outside the dispenser 200.

When the motor 204 is activated, using the manually operable switch, the cam 208 rotates and the pins 210 all move in arcs. As soon as movement starts, the micro switch closes. More specifically, one of the pins 210 normally holds the micro switch open and the initial movement of the pin 210 which was holding the switch open allows it to close. Thus opening of the manually operable switch does not result in the motor 204 stopping as power to the motor 204 is now supplied through the micro switch.

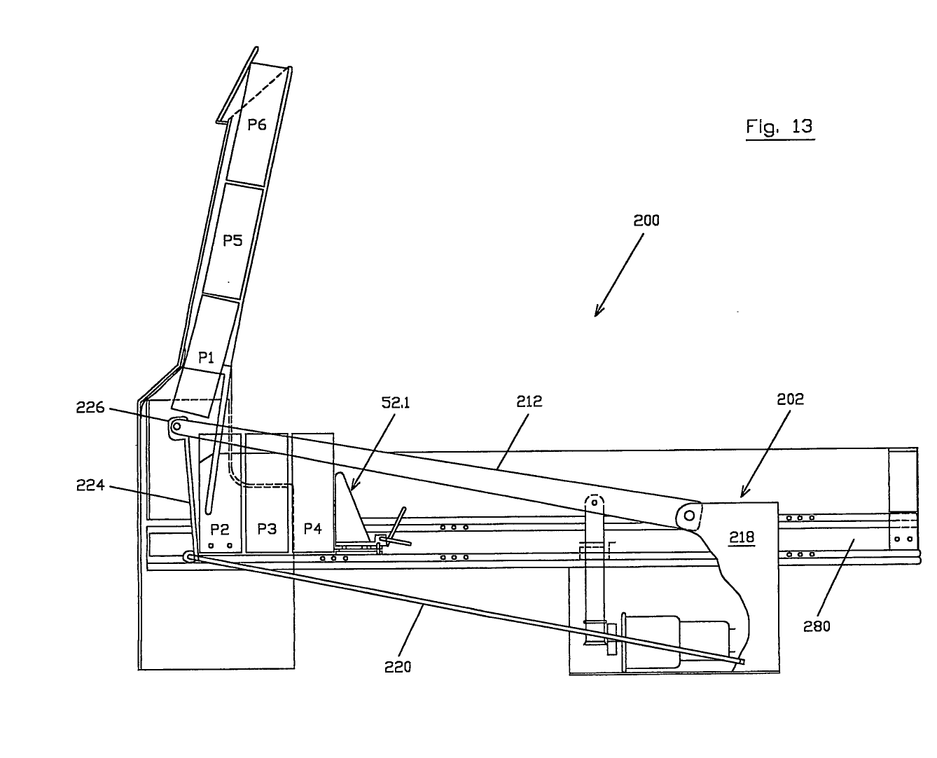

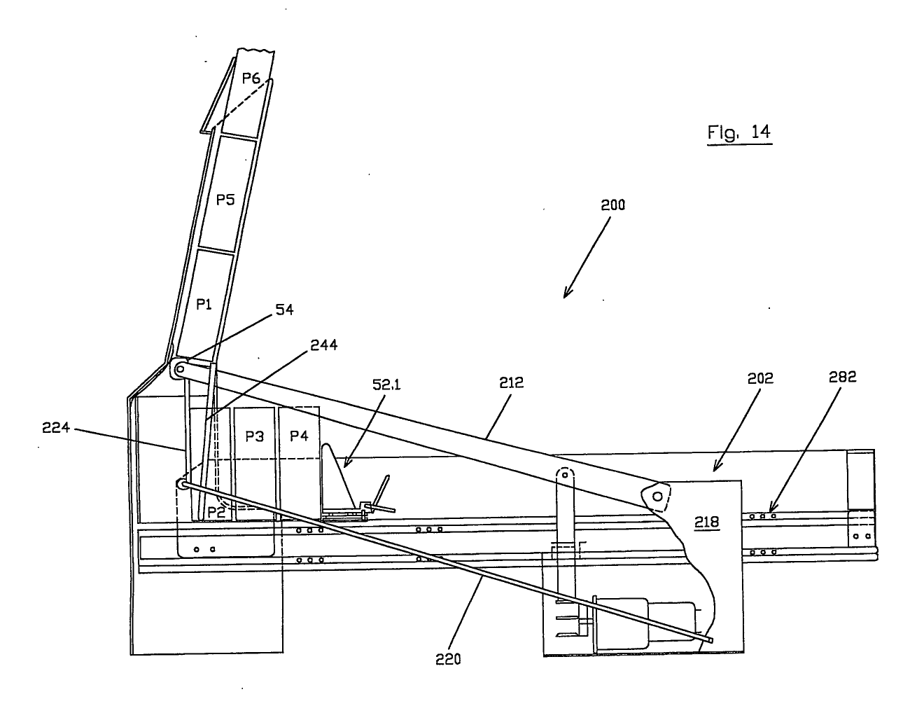

Another of the pins 210 lifts the element 228 and hence swings the entire lever structure 214 in an upward arc (see FIGS. 13 and 14).

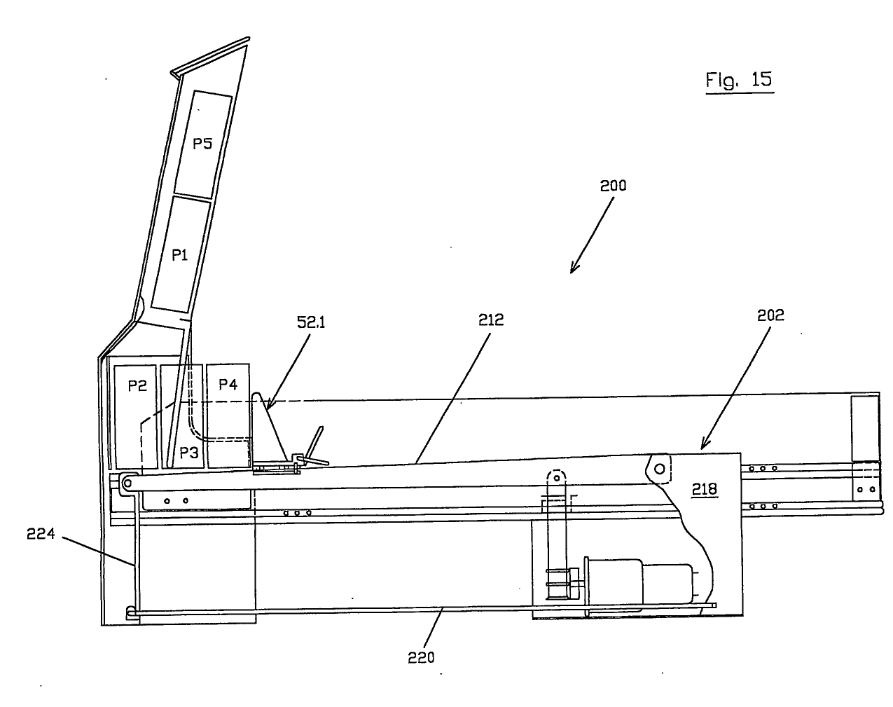

As the platform 226 lifts with the rest of the lever structure 214, the packet P1 is pushed upwards (FIG. 13). It lifts out of the lower section 234 into the section 236 and as it does so it pushes the packets P5 and P6 upwardly. This causes the packet P6 to bear on the underside of the lid 250 and pivot it upwards. This packet P6 now becomes available for removal from the dispenser 200. The plate 224 prevents the packet P2, and hence the packets P3, P4 and the pressure plate 52.1, from moving forward whilst the lever structure 214 is raised. However, as soon as the lever structure 214 drops, the packets P2, P3, P4 and the pressure plate 52.1 move forward (see FIG. 15) under the influence of the strip 72.

The upper, forward edge of the packet P1 encounters the vertical legs 258 of the spring 256 and its upper end of the packet P1 is tilted rearwardly. As said upper forward edge clears the spring's cross member 260, the cross member 260 presses on the front face of the packet P1 pushing it against the rear wall 246. This movement ensures that the lower edge of the packet P1 moves to a position over the packet supports 252 and is thus prevented from dropping back into the section 234.

The arrangement is such that the pin 210 which lifted the element 228 disengages from it by rotating out from underneath it as the lever structure 214 reaches its upper position. The lever structure 214 thus drops down to the illustrated position. A spring (not shown) which becomes effective just before the lever structure 214 reaches its bottom position, can be provided to pull the structure 214 all the way down. As soon as the lever structure 214 drops, the packets P2, P3, P4 and the pressure plate 52.1 move forward. The packet P2 is now on the platform 226.

One of the pins 210 at this stage opens the micro switch and the motor 204 is de-energized.

A micro switch (not shown) can be provided which is operated by the packet (P6 as illustrated) as it emerges from the column section 236.

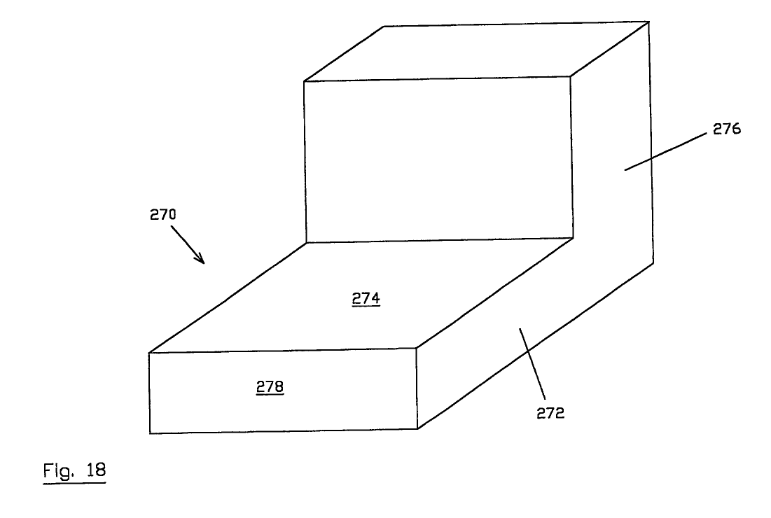

A plurality of the dispensers 10, 200 described can be placed side-by-side in a lockable container 270 (see FIG. 18). The container 270 has a first compartment 272 for receiving the magazines 14, 14.1, the first compartment 272 having a top surface 274 on which a cash register (not shown) can stand.

The lower end of a second compartment 276 merges with the front end of the first compartment 272. The columns 12, 12.1 stand up in the compartment 276.

The rear wall 278 of the compartment 272 can be in the form of a lockable door.

The magazines 14, 14.1 are mounted as a unit on a fixed rail structure 280, such as is found in filing cabinets which has drawers that slide in and out, and this unit can thus slide out of the compartment 272 for loading purposes (as shown in FIG. 11). The magazines 14, 14.1 and columns 12, 12.1 are thus not connected to one another but merely come into co-operating relationship as the unit comprising the loaded magazines is slid back into the first compartment 272.

Closing of the door causes the cams 50, 50.1 to come into contact with the inwardly facing surface of the door. The movement of the cams 50, 50.1 frees the latches 66, 66.1 from their corresponding retaining elements 48,48.1 thereby releasing the pressure plates 52, 52.1. In this way the closing of the door ensures that no pressure plate 52, 52.1 remains in the latched position when the door is closed and the dispenser 10, 200 is operational.

A switch (not shown), or similar detecting means, can be located within the door to ensure that power cannot be provided to the dispenser 10, 200 unless the door is in its closed position.

A micro switch (not shown) can be provided adjacent the upper end of the column 12.1, in the same way that the micro switch 22 is provided at the upper end of the column 12, and positioned so that it is operated each time a packet is forced upwardly out of the column 12.1.

1. A dispenser for dispensing packets particularly, but not exclusively, cigarette packets, said dispenser comprising a magazine for holding a plurality of packets standing in an upright position, means for pushing the plurality of packets towards a dispensing end of the magazine, means defining a column at said dispensing end of the magazine, means for lifting the leading packet of the plurality upwards out of the magazine and into said column and means for supporting a packet that has been lifted into said column to prevent the packet from dropping back down said column.

2. A dispenser as claimed in claim 1, and including a displaceable closure element located at the upper end of said column, a packet at the upper end of the column, when being lifted in the column, engaging and displacing the closure element to permit that packet to emerge from the upper end of the column.

3. A dispenser as claimed in claim 2, wherein said closure element is in the form of a hinged lid, a packet at the upper end of the column, when being lifted in the column, pressing on the lid to lift it and permitting that packet to emerge from the upper end of the column.

4. A dispenser as claimed in claim 2, wherein said closure element is in the form of an elongate comb with flexible bristles, a packet at the upper end of the column, when being lifted in the column, displacing the flexible bristles and protruding therethrough.

5. A dispenser as claimed in any preceding claim, wherein said means for pushing the packets towards the dispensing end of the magazine comprises a pressure plate and a spring.

6. A dispenser as claimed in claim 5, wherein said spring is an elongate leaf spring which is wound to coil form, the inner end of the wound coil being fixed and the outer end of the coil being attached to the pressure plate.

7. A dispenser as claimed in any preceding claim, and including sensor means located at the upper end of the column, said sensor means being activated by a packet being dispensed.

8. A dispenser as claimed in any one of claims 1 to 7, wherein said lifting means comprises a lever structure which is pivotally mounted at one end and which has a platform at the other end, there being means for swinging said lever structure in an upward arc so that said platform bears on the underside of a packet to be lifted.

9. A dispenser as claimed in claim 8, wherein said lever structure is in the form of a parallelogram linkage so that said platform moves vertically.

10. A dispenser as claimed in claim 8 or 9, wherein said means for swinging the lever structure in an upward arc comprises a rotatable cam with lobes one of which, each time the cam rotates, bears on the underside of said lever structure to lift said structure.

11. A dispenser as claimed in any one of claims 1 to 7, wherein said lifting means comprises an elongate resiliently flexible element, there being means for reciprocating said element so that one end of the element bears on the underside of a packet to be lifted.

12. A dispenser as claimed in claim 11, and comprising a first spool, an electric motor for driving said first spool, a second spool, an endless belt entrained around said spools and a linkage connected to said belt for reciprocal movement as the belt moves, said linkage being connected to said flexible element for reciprocating said flexible element.

13. A dispenser as claimed in claim 11 or 12, and including aligning means in the form of a plurality of spools, said resiliently flexible element passing between said spools and being aligned with the column by the spools.

14. A dispensing apparatus comprising a first compartment having a top surface on which a cash register can stand, a second compartment which is vertically elongate, one end of the first compartment communicating with the lower end of the second compartment, a plurality of dispensers as defined above in said compartments, said magazines being side-by-side in the first compartment and said columns being side-by-side in the second compartment.

15. A dispensing apparatus as claimed in claim 14, wherein said second compartment, on the side thereof remote from the first compartment, has a transparent window so that packets in the columns in the second compartment are visible from outside the dispensing apparatus.
